(19) United States
(12) Patent Application Publication
(10) Pub. No.: US 2022/0215466 A1
(43) Pub. Date: Jul. 7, 2022

(54) AUTOMATIC ACCOUNT MANAGEMENT MODIFICATIONS TO AFFECT PREDICTED FUTURE EVENTS

(71) Applicant: Capital One Services, LLC, McLean, VA (US)

(72) Inventors: Austin Walters, Savoy, IL (US); Jeremy Goodsitt, Champaign, IL (US); Vincent Pham, Champaign, IL (US); Alvin Hua, Clarksburg, MD (US)

(73) Assignee: Capital One Services, LLC, McLean, VA (US)

(21) Appl. No.: 17/141,834

(22) Filed: Jan. 5, 2021

(51) Int. Cl. G06Q 40/02; G06Q 30/02; G06Q 20/12

(52) U.S. Cl. CPC G06Q 40/025; G06Q 20/127; G06Q 30/0202

(57) ABSTRACT

A processor may identify a recurring event within account data including a plurality of events associated with an account. The processor may determine that the recurring event did not occur at an expected date. The processor may predict a time from the expected date to an expected triggered event that is triggered by the recurring event not occurring at the expected date. The predicting may include determining a class of the recurring event from a plurality of classes and selecting, as the time from the expected date to the expected triggered event, an approximate elapsed time after which a party to the expected triggered event is known to have previously initiated triggered events for the determined class. Before the time from the expected date to the expected triggered event elapses, the processor may cause a server that manages the account to make an automatic modification to an account setting.

### BACKGROUND

Many systems today are controlled at least partially automatically. For example, many systems are configured so that after an initial set of parameters or goals are prescribed, the system itself can automatically or semi-automatically configure itself to adhere to the parameters or meet the goals. Such systems can change configuration in response to changes to internal and/or external factors. However, these configuration changes are often prompted by a detection of the changes to internal and/or external factors and therefore happen after the fact (e.g., as in a feedback loop). Feedback has been used in many systems for many reasons and with many benefits. However, feedback does not allow for configuration changes to be made in advance of predicted future changes to internal and/or external factors.

In some cases, it may be more useful to make a configuration change to prevent or mitigate future events than to make the configuration change after the fact. This could improve both the automatic systems management processing itself (e.g., causing fewer configuration changes to be required for good system performance) and have the beneficial effect of preventing or mitigating undesirable problems caused by future events within and/or outside of the automatically managed systems.

### SUMMARY OF THE DISCLOSURE

In some embodiments described herein, a method may include identifying, with a processor, a recurring event within account data including a plurality of events associated with an account. The method may include determining, with the processor, that the recurring event did not occur at an expected date. The method may include predicting, with the processor, a time from the expected date to an expected triggered event that is triggered by the recurring event not occurring at the expected date. The predicting may include determining a class of the recurring event from a plurality of classes. The predicting may also include selecting, as the time from the expected date to the expected triggered event, an approximate elapsed time after which a party to the expected triggered event is known to have previously initiated triggered events for the determined class. The method may further include, before the time from the expected date to the expected triggered event elapses, causing, by the processor, a server that manages the account to make an automatic modification to an account setting. The automatic modification may be configured to prevent the expected triggered event from occurring or to mitigate an effect of the expected triggered event.

In some embodiments, the plurality of events associated with the account may have occurred over a plurality of months. In some such embodiments, the identifying of the recurring event may include identifying multiple events associated with the party to the expected triggered event that reoccur on a monthly basis for at least two of the plurality of months and calculating, based on respective dates of each of the multiple events, the expected date for the recurring event.

In some embodiments, each of the plurality of classes may correspond to a respective range of numeric values. In some such embodiments, the determining of the class of the recurring event may include identifying a numeric value for the recurring event and assigning the recurring event to the class corresponding to the range in which the numeric value for the recurring event lies.

In some embodiments, the predicting may further include receiving income prediction data associated with the account, detecting, in the income prediction data, a predicted reduction in income, and adjusting the time from the expected date to the expected triggered event downward in response to the predicted reduction in income.

In some embodiments, the automatic modification to the account setting may include changing a priority of future recurring events, canceling at least one future recurring event, or a combination thereof.

In some embodiments, the recurring event is a payment, the expected triggered event is a collections event, and the party is a payee. In some such embodiments, the selecting may include determining the approximate elapsed time from at least one time between at least one previously missed payment and at least one previous collections event in credit report data associated with the payee and the class.

In some embodiments, the predicting may further include, for each of a plurality of additional accounts, performing processing including one or more of the following: identifying, with the processor, a respective recurring event within respective account data including a respective plurality of events associated with the respective account of the plurality of additional accounts; determining, with the processor, that the respective recurring event did not occur at a respective expected date; determining, with the processor, a class of the respective recurring event from the plurality of classes; identifying, with the processor, a respective triggered event corresponding to the respective recurring event within reporting data, the respective triggered event associated with the party; and determining, with the processor, a respective elapsed time between the respective expected date and the respective triggered event. In some such embodiments, the predicting may further include determining, with the processor, the approximate elapsed time after which a party to the expected triggered event is known to have previously initiated triggered events for the determined class as an output of a calculation using each of the respective elapsed times as input.

In some embodiments described herein, a method may include for each of a plurality of accounts, performing processing including one or more of the following: identifying, with a processor, a respective recurring event within respective account data including a respective plurality of events associated with the respective account of the plurality of accounts; determining, with the processor, that the respective recurring event did not occur at a respective expected date; determining, with the processor, a class of the respective recurring event from a plurality of classes; identifying, with the processor, a respective triggered event corresponding to the respective recurring event within reporting data, the respective triggered event associated with a party; and determining, with the processor, a respective elapsed time between the respective expected date and the respective triggered event. The method may include determining, with the processor, an approximate elapsed time for the class and the party as an output of a calculation using each of the respective elapsed times as input. The method may include establishing, by the processor, an automatic account modification protocol that is configured to cause a server that manages at least one of an additional account and one or more of the plurality of accounts to make an automatic modification to an account setting in response to detecting a recurring event associated with the class and the party failing to occur. The method may include automatically modifying the account setting according to the automatic account modification protocol.

In some embodiments, for each of the plurality of accounts, the respective plurality of events associated with the respective account may have occurred over a plurality of months. In some such embodiments, the identifying of the respective recurring event may include identifying multiple events associated with the party to the respective expected triggered event that reoccur on a monthly basis for at least two of the plurality of months and calculating, based on respective dates of each of the multiple events, the respective expected date for the respective recurring event.

In some embodiments, each of the plurality of classes may correspond to a respective range of numeric values. In some such embodiments, for each of the plurality of accounts, the determining of the class of the respective recurring event may include identifying a respective numeric value for the respective recurring event and assigning the respective recurring event to the class corresponding to the range in which the respective numeric value for the respective recurring event lies.

In some embodiments, the automatic modification to the account setting may include changing a priority of future recurring events, canceling at least one future recurring event, or a combination thereof.

In some embodiments, the automatic account modification protocol may include detecting that the recurring event associated with the class and the party has failed to occur.

In some embodiments, the automatic modification may be configured to prevent an expected triggered event from occurring or to mitigate an effect of the expected triggered event.

In some embodiments described herein, a system may include a processor and a server in communication with the processor. The processor may be configured to perform processing including identifying a recurring event within account data including a plurality of events associated with an account, determining that the recurring event did not occur at an expected date, and predicting a time from the expected date to an expected triggered event that is triggered by the recurring event not occurring at the expected date. The predicting may include determining a class of the recurring event from a plurality of classes and selecting, as the time from the expected date to the expected triggered event, an approximate elapsed time after which a party to the expected triggered event is known to have previously initiated triggered events for the determined class. The server may be configured to perform processing including, before the time from the expected date to the expected triggered event elapses, making an automatic modification to an account setting, the automatic modification being configured to prevent the expected triggered event from occurring or to mitigate an effect of the expected triggered event.

In some embodiments, the plurality of events associated with the account may have occurred over a plurality of months. In some such embodiments, the processor may be configured to identify the recurring event by performing processing including identifying multiple events associated with the party to the expected triggered event that reoccur on a monthly basis for at least two of the plurality of months and calculating, based on respective dates of each of the multiple events, the expected date for the recurring event.

In some embodiments, each of the plurality of classes may correspond to a respective range of numeric values. In some such embodiments, the processor may be configured to determine the class of the recurring event by performing processing comprising identifying a numeric value for the recurring event and assigning the recurring event to the class corresponding to the range in which the numeric value for the recurring event lies.

In some embodiments, the predicting may further include receiving income prediction data associated with the account, detecting, in the income prediction data, a predicted reduction in income, and adjusting the time from the expected date to the expected triggered event downward in response to the predicted reduction in income.

In some embodiments, the server may be configured to make the automatic modification to the account setting by performing processing comprising changing a priority of future recurring events, canceling at least one future recurring event, or a combination thereof.

In some embodiments, the recurring event is a payment, the expected triggered event is a collections event, and the party is a payee. In some such embodiments the selecting may include determining the approximate elapsed time from at least one time between at least one previously missed payment and at least one previous collections event in credit report data associated with the payee and the class.

In some embodiments, the processor may be configured to perform the predicting by, for each of a plurality of additional accounts, performing processing including identifying a respective recurring event within respective account data including a respective plurality of events associated with the respective account of the plurality of additional accounts; determining that the respective recurring event did not occur at a respective expected date; determining a class of the respective recurring event from the plurality of classes; identifying a respective triggered event corresponding to the respective recurring event within reporting data, the respective triggered event associated with the party; and determining a respective elapsed time between the respective expected date and the respective triggered event. In some such embodiments, the processor may be configured to determine the approximate elapsed time after which a party to the expected triggered event is known to have previously initiated triggered events for the determined class as an output of a calculation using each of the respective elapsed times as input.

### BRIEF DESCRIPTIONS OF THE FIGURES

FIG. 1 shows an automatic account modification system according to some embodiments of the disclosure.

FIG. 2 shows a process for automatically modifying an account setting according to some embodiments of the disclosure.

FIG. 3 shows a process for building expected triggered event timing data according to some embodiments of the disclosure.

FIG. 4 shows a process for identifying event non-recurrence according to some embodiments of the disclosure.

FIG. 5 shows a process for determining a time to expected triggered event according to some embodiments of the disclosure.

FIG. 6 shows a process for automatically modifying an account setting according to some embodiments of the disclosure.

FIG. 7 shows a process for automatically modifying an account setting to avoid delinquency or provide some other remedy according to some embodiments of the disclosure.

FIG. 8 shows a process for building bill to collections timing data according to some embodiments of the disclosure.

FIG. 9 shows a process for identifying possible delinquency according to some embodiments of the disclosure.

FIG. 10 shows a process for determining a time to collections event according to some embodiments of the disclosure.

FIG. 11 shows a process for automatically modifying an account setting to avoid delinquency or provide some other remedy according to some embodiments of the disclosure.

FIG. 12 shows a computing device according to some embodiments of the disclosure.

### DETAILED DESCRIPTION OF SEVERAL EMBODIMENTS

Embodiments described herein include systems and methods that may automatically modify system parameters to address expected future events. For example, automatic modification may be performed to prevent the expected event from occurring or to mitigate an effect of the expected event. In some embodiments, the system being modified may be an automatically or semi-automatically managed account within a computing system. In a specific, non-limiting example presented for demonstration purposes, the account may be a bank account from which withdrawals are automatically made, and the future event may be a negative financial event such as a handover of a delinquent debt to a collections agency.

Embodiments described herein may make predictions about when an expected event is likely to occur and take action before the predicted time of the expected event. Predictions may be based on historical data from disparate sources that has been correlated and analyzed. Some embodiments may perform this correlation and analysis themselves. Once timing data is available, systems and methods described herein may monitor events that are internal to the system (e.g., account activity) and use them to recognize that future external events are likely to be triggered by the internal events. This may include predicting how much time is likely to elapse between the internal events and the external, expected triggered events. Before such time elapses, the disclosed systems and methods may modify account settings to prevent or mitigate effects of the expected triggered events.

Disclosed embodiments may be able to prevent the expected triggered events altogether, or at least reduce negative effects of the expected triggered events, through automatic preemptive action. Due to the innovations described herein, automatically controlled systems can be preemptively reconfigured. Because some types of events can be predicted with reasonably high certainty, it can be clearly understood that this preemptive reconfiguration has the practical effect of preventing these events when they do not occur. Likewise, even if the events cannot be prevented altogether, account settings can be adjusted so that negative effects of the events (e.g., depletion of resources managed by the account) can be reduced. These are advantageous practical outcomes that the disclosed embodiments allow automatically managed systems to realize.

Moreover, disclosed embodiments may provide the further technical advantage of improving automatic account setting optimization and/or reducing the processing needed to automatically manage accounts. For example, processing can be reduced and settings optimized by making preemptive changes that obviate the need for future setting changes in response to events and/or prevent negative impacts on the account itself due to the events.

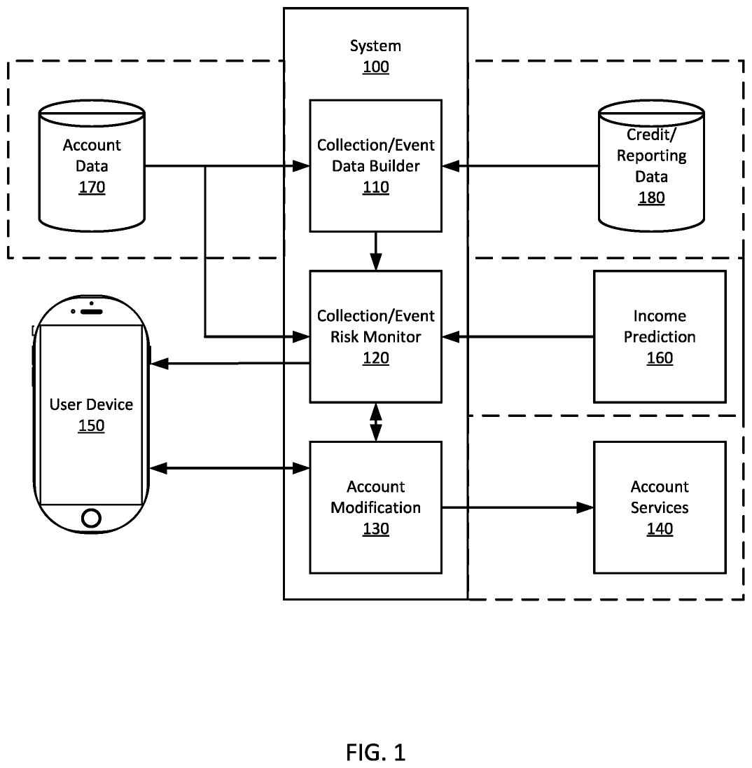

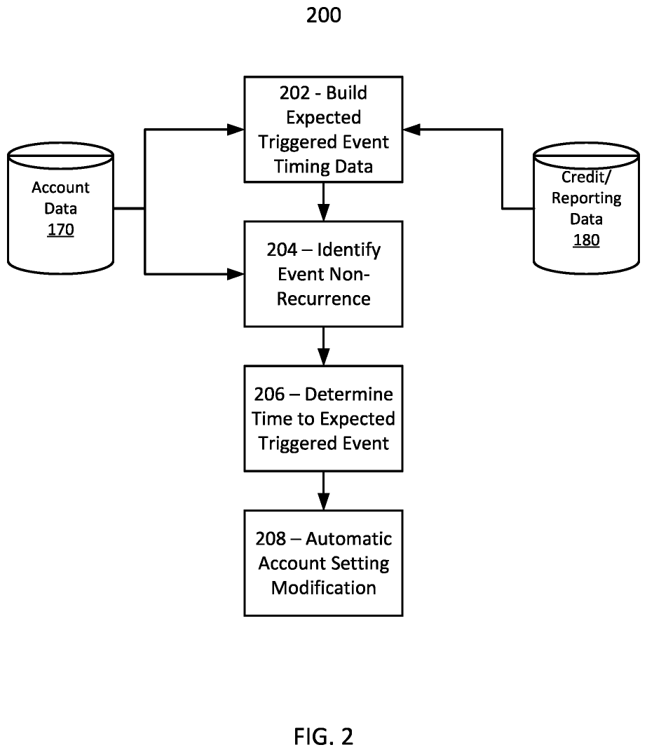

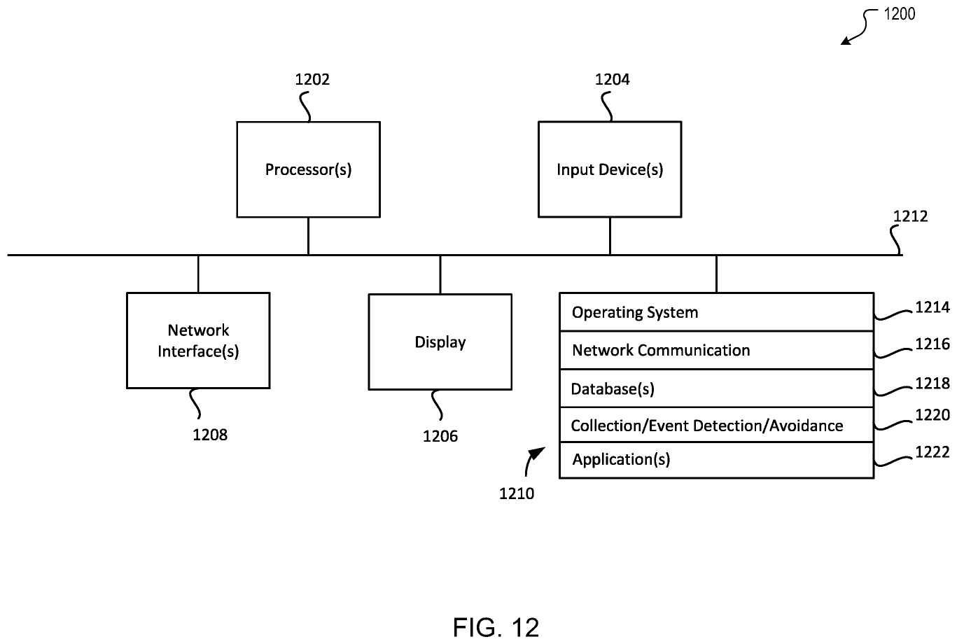

FIG. 1 shows an automatic account modification system 100 according to some embodiments of the disclosure. Automatic account modification system 100, alone or in combination with other elements, may be configured to perform a variety of automatic account management processes such as those described below with respect to FIGS. 2-11. Automatic account modification system 100 may include one or more processors and/or one or more servers or other computers comprising one or more processors. Example computers that may be used within automatic account modification system 100 are described below with respect to FIG. 12.

In some embodiments, automatic account modification system 100 may include collection/event data builder 110, collection/event risk monitor 120, and/or account modification engine 130.

As described in detail herein, collection/event data builder 110 may gather data from a plurality of sources to generate data that can be used to predict events. Sources may include account data 170 and/or credit reporting data 180, either of which may be included within automatic account modification system 100 or provided by some external source or sources in various embodiments.

Collection/event risk monitor 120 may monitor account data 170 and/or other data sources (e.g., data supplied by income prediction engine 160) to determine that future events may be triggered by events indicated within this monitored data. Income prediction engine 160 may be a component of automatic account modification system 100 or provided by some external source or sources in various embodiments.

Account modification engine 130 may modify account settings and/or cause other automated actions to prevent or mitigate effects of the expected triggered events. In some embodiments, this may include directing account services 140 to take action. Account services 140 may be a component that is configured to perform the account modifications and/or take other actions on the account. Account services 140 may be a component of automatic account modification system 100 or provided by some external source or sources in various embodiments.

In some embodiments, components of automatic account modification system 100 may be in communication with and/or supplied by user device 150, which may be a computing device such as a smartphone, tablet, computer, smartwatch, or any other computing device configured to provide account access to a user. For example, as described in detail below, collection/event risk monitor 120 may alert a user of predicted future events, and/or account modification engine 130 may advise the user of the modifications being made and, in some cases, request user confirmation of the modifications.

The various elements of automatic account modification system 100 and/or external elements with which they interface may be supplied as a system of software and/or firmware executed by the same hardware elements, a set of distributed or networked hardware elements, or a combination thereof. For example, elements may communicate with one another using the Internet and/or other public or private networks or combinations thereof. For example, communication between the elements may be facilitated by one or more application programming interfaces (APIs). APIs of system 100 may be proprietary and/or may be examples available to those of ordinary skill in the art such as Amazon® Web Services (AWS) APIs or the like.

User device 150 may be any device configured to present user interfaces and receive inputs thereto. For example, user device 150 may be a smartphone, personal computer, tablet, laptop computer, or other device. Detailed examples of the data exchanged between user device 150 and other automatic account modification system 100 elements are provided below.

Automatic account modification system 100 elements are each depicted as single blocks for ease of illustration, but those of ordinary skill in the art will appreciate that collection/event data builder 110, collection/event risk monitor 120, account modification engine 130, account services 140, user device 150, income prediction engine 160, account data 170 database, and/or credit/reporting data 180 database may be embodied in different forms for different implementations. For example, automatic account modification system 100 may include a plurality of servers. Alternatively, the operations performed by multiple elements may be performed on a single server. In another example, a plurality of user devices 150 may communicate with collection/event risk monitor 120 and/or account modification engine 130. A single user may have multiple user devices 150, and/or there may be multiple users each having their own user device(s) 150. Any number and/or type of account data 170 and/or credit/reporting data 180 sources may be available locally and/or through one or more networks.

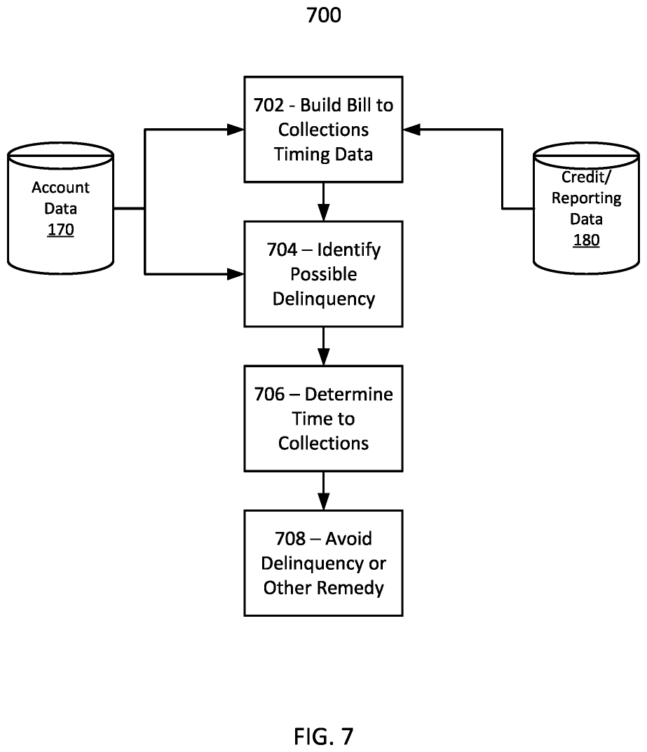

FIG. 2 shows a process 200 for automatically modifying an account setting according to some embodiments of the disclosure. Process 200 is an example of an overall process that may be performed by automatic account modification system 100, including generating data useful for making predictions, actually making the predictions, and taking action based on the predictions. FIG. 7, discussed below, presents a specific example of the overall process that is used to modify financial account management settings to avoid payment delinquencies or realize other financial benefits. However, process 200 may be applicable to a wide variety of automatically managed accounts.

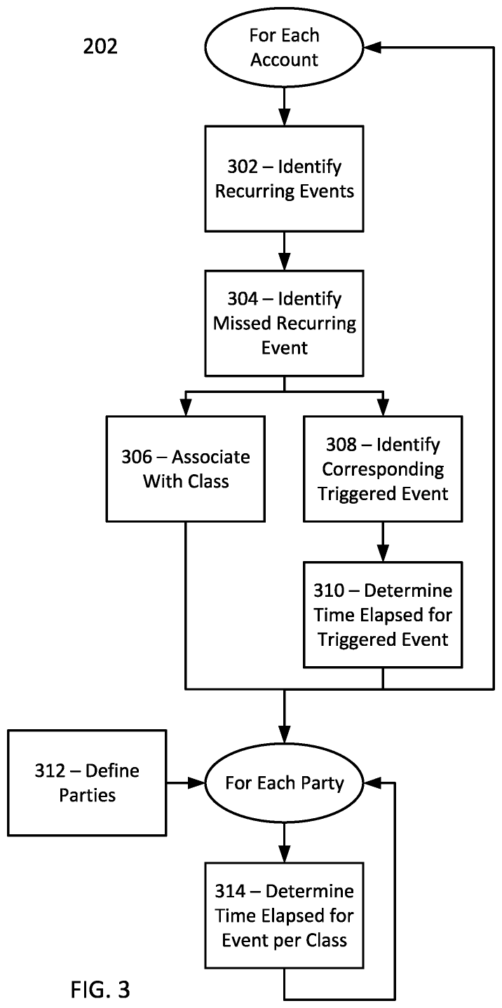

At 202, automatic account modification system 100 may build expected triggered event timing data. For example, automatic account modification system 100 may correlate account-related events visible in account data 170 with subsequent external events visible in credit/reporting data 180. In some embodiments, automatic account modification system 100 may leverage access to generally inaccessible (e.g., private) data to make these correlations. Examples of generally inaccessible data may include, but are not limited to, private account information (e.g., in account data 170) that automatic account modification system 100 may only have due to being integrated with an account management service and/or private credit or other data (e.g., in credit/reporting data 180) that automatic account modification system 100 may only have due to prior consent from account holders. Specific processing that may be performed to build expected triggered event timing data 202 is described in detail with respect to FIG. 3 below. Building triggered event timing data is illustrated as part of process 200 herein, but in some embodiments, automatic account modification system 100 may receive pre-built triggered event timing data from a data source and continue with process 200.

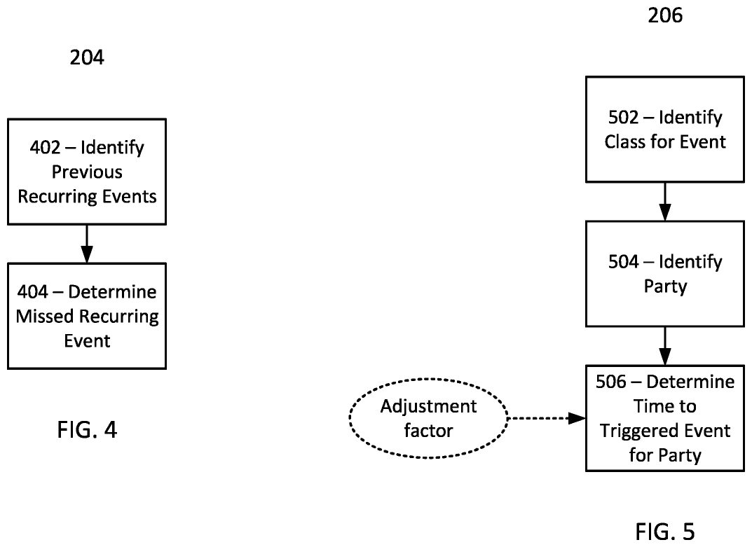

At 204, automatic account modification system 100 may identify non-recurrence of an event. For example, account data 170 may include records of recurring account-related events, such as events that recur monthly or with some other periodicity. Then, automatic account modification system 100 may determine that a recurring event did not recur for a given time period (e.g., a monthly event was skipped in a given month). Specific processing that may be performed to identify non-recurrence of an event 204 is described in detail with respect to FIG. 4 below.

At 206, automatic account modification system 100 may determine a time to an expected triggered event. For example, using the expected triggered event timing data from 202, automatic account modification system 100 may be able to identify time elapsed between past triggered events and past missed recurring events of a similar type to the event that was determined not to recur at 204. Automatic account modification system 100 may base a time prediction on the identified previous elapsed times. Specific processing that may be performed to determine a time to an expected triggered event 206 is described in detail with respect to FIG. 5 below.

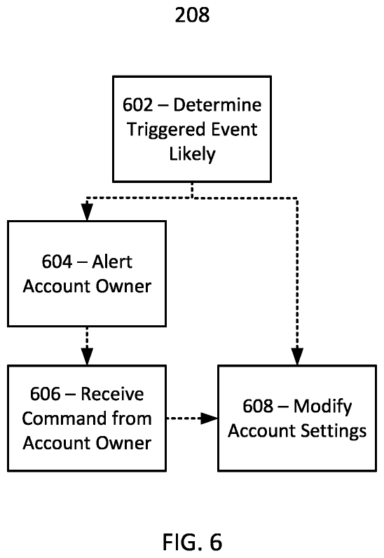

At 208, automatic account modification system 100 may perform automatic account setting modification. Based on the nature of the expected triggered event, one or more account modifications may be available to mitigate harm from the expected triggered event and/or prevent the expected triggered event from occurring altogether. Automatic account modification system 100 may identify these modifications and apply them directly or, in some cases, after obtaining user consent. Specific processing that may be performed to automatically modify an account setting 208 is described in detail with respect to FIG. 6 below.

FIG. 3 shows a process 202 for building expected triggered event timing data according to some embodiments of the disclosure. Automatic account modification system 100 may perform process 202 as a preliminary setup procedure to enable subsequent account monitoring and automatic modification in some embodiments. The expected triggered event timing data may be used for account monitoring, as described below with respect to FIG. 4, for example.

In some embodiments, collection/event data builder 110 may be the component of automatic account modification system 100 that performs process 202. However, process 202 is described below with respect to automatic account modification system 100 generally to indicate that other embodiments may allow for other distributions of processing among components of automatic account modification system 100.

Automatic account modification system 100 may take account data 170 for a plurality of accounts and credit/reporting data 180 for the same plurality of accounts (or some subset of the plurality of accounts or overlapping set including at least some of the same accounts) as inputs. For each account indicated in or associated with the account data 170, automatic account modification system 100 may perform processing at 302-310.

At 302, automatic account modification system 100 may identify a periodically (e.g., monthly) recurring event within account data of an account being analyzed. The account data may include a plurality of events associated with the account. Automatic account modification system 100 may recognize one or more of the plurality of events as recurring events based on one or more respective characteristics of the events. For example, events having common or very similar characteristics may repeat in a recognizable pattern, and automatic account modification system 100 may identify such events as recurring events. Automatic account modification system 100 may also determine the period of the event's recurrence (e.g., daily, weekly, monthly, once every X days, etc.).

If no recurring events are identified for a given account, automatic account modification system 100 may select another account for analysis and repeat processing at 302 with the new account's data. If there are no further accounts to analyze, process 202 may end.

One example of an identifiable recurring event is a recurring monthly payment to a payee or creditor. A specific discussion of this example is given below with respect to FIGS. 7-11. Automatic account modification system 100 may be used to detect many other types of identifiable recurring events besides payments. Another example may be a regular meeting in a set of account data that includes calendar data. The account data may include a plurality of calendar entries, each of which has a set of data fields that may include, date, time, location, duration, invitees, topic, etc. Based on repeated data fields such as common invitees each time, a same topic or title each time, a same duration each time, and similar date/time/location (e.g., every Tuesday at 10 AM in room 1A, once every 30 days via videoconference, etc.), automatic account modification system 100 may correlate recurring calendar entries and determine they represent a recurring event. Automatic account modification system 100 may also determine the period of the event's recurrence (e.g., a weekly meeting) and/or an expected date and/or time for the recurrence (e.g., every Monday, the 10^{th} of every month, etc.). These examples are presented for illustration purposes only, and it should be understood that any account data set can be analyzed to identify recurring events based on repeated entries having common characteristics.

At 304, automatic account modification system 100 may determine that a periodically (e.g., monthly) recurring event identified at 302 did not occur at an expected date. For example, the analysis at 302 may reveal that a meeting having a title “Lunch with Fred” and an invitation extended to Fred takes place every Monday at noon, or a payment of a specific amount or range of amounts is deducted on the 3^{rd} of every month unless that day is a Saturday or Sunday (in which case it is deducted on the 2^{nd} or the 4^{th}). Thus, gaps in the periodic recurrence of the event may be identified. For example, automatic account modification system 100 may check the account data for each expected recurrence of the event and, if there is no record of the event in the account data, automatic account modification system 100 may determine that the event did not occur at the expected date. For example, entries for a specific Monday may include no record of a meeting with Fred, or entries for the 3^{rd} of September (and 2^{nd} and 4^{th} of September) include no record of a deduction of the specific payment amount. In this event, automatic account modification system 100 may determine that the recurring event did not occur at the expected date.

If no recurring events are identified as being missed at an expected date for a given account, automatic account modification system 100 may select another account for analysis and repeat processing at 302 and 304 with the new account's data. If there are no further accounts to analyze, process 202 may end.

At 306, for any recurring event(s) that were identified as being missed at 304, automatic account modification system 100 may associate the missed event with a class. For example, automatic account modification system 100 may determine a class of the monthly recurring event from a plurality of classes into which such events may be classifiable. In some embodiments, each of the plurality of classes may correspond to a respective range of numeric values. In some such embodiments, the determining of the class of a respective monthly recurring event may include identifying a numeric value for the monthly recurring event and assigning the monthly recurring event to the class corresponding to the range in which the numeric value for the monthly recurring event lies. For example, there may be a class for a range of values or “buckets” from 0-99, another class for values from 100-199, another for 200-299, etc. Other numeric ranges may be used, and these are presented for example only. Continuing the calendar example, there may be separate classes based on day of the week, time of day, etc. So, for example, a missed meeting may be in one class if it was to be a morning meeting, and a different class if it was to be an afternoon meeting.

At 308, for any recurring event(s) that were identified as being missed at 304, automatic account modification system 100 may identify a triggered event corresponding to the missed monthly recurring event within credit/reporting data 180. At this stage of process 202, automatic account modification system 100 may be able to correlate the missed events with the subsequent external events visible in credit/reporting data 180. To make the correlation, automatic account modification system 100 may identify, within credit/reporting data 180, an event that corresponds to the missed event that originated from account data 170. For example, the respective events can be correlated by common or related characteristics. Using credit data as an example, a collections event in the same dollar amount as a missed payment identified at 304, and in some cases having the same payee, may be correlated due to the same amount and/or same payee. In the meeting example, a subsequent meeting may be correlated with a missed meeting based on having the same attendees, title, distributed attachments, etc. Any criteria may be matched or otherwise correlated to identify corresponding triggered events.

As noted above, some embodiments of automatic account modification system 100 may leverage access to generally inaccessible (e.g., private) data to make these correlations. Examples of generally inaccessible data may include, but are not limited to, private account information (e.g., in account data 170) that automatic account modification system 100 may only have due to being integrated with an account management service and/or private credit or other data (e.g., in credit/reporting data 180) that automatic account modification system 100 may only have due to prior consent from account holders.

At 310, automatic account modification system 100 may determine an elapsed time between the expected date of the missed event and the triggered event. Here, automatic account modification system 100 may perform a calculation determining the difference between a scheduled or otherwise expected date and/or time for the missed event and a time indicated in credit/reporting data 180 for the triggered event. The scheduled or otherwise expected date and/or time for the missed event may have been determined at 302 (e.g., the expected time and/or date based on previous patterns). Credit/reporting data 180 may indicate the triggered event's time and/or date either by including it in the description of the triggered event or by first showing up within credit/reporting data 180 at a particular time and/or date, for example.

Automatic account modification system 100 may perform processing at 302-310 for each account indicated in or associated with the account data 170. Accordingly, as illustrated in FIG. 3, processing at 302-310 may be repeated until all available accounts (or a desired subset thereof) have been evaluated as described.

After processing at 302-310 for a plurality of accounts, automatic account modification system 100 may have a data set indicating expected timings for a variety of events and classes of events. For example, for each of a plurality of numeric value buckets as the classes, a subsequent triggered event may have an expected timing. Specifically, for illustration purposes only, a triggered event may occur 60 days after a missed event in a 0-999 bucket, whereas a triggered event may occur 30 days after a missed event in a 1000-9999 bucket. However, some embodiments may further define event timings not only based on classes, but also based on the tendencies of a plurality of parties to the events. For example, there may be a plurality of different parties that show up in the credit/reporting data 180. Different parties may trigger events at different timings (e.g., as determined at 310). For each party, automatic account modification system 100 may perform processing at 312-314 to identify differences in timing among parties, even for similar classes of events.

At 312, automatic account modification system 100 may define the parties in some embodiments. In some cases, automatic account modification system 100 may receive or access a list of parties associated with credit/reporting data. In other cases, automatic account modification system 100 may read credit/reporting data and identify parties to events (for example, entities listed in “attendee” or “payee” fields or other fields associated with identifiable parties).

At 314, automatic account modification system 100 may determine times elapsed per events per classes for each party. For example, automatic account modification system 100 may determine an approximate elapsed time for the class and the party as an output of a calculation using each of a plurality of respective elapsed times as input. This may be done, for example, by selecting each event identified at 308 for a given party, identifying the class of the event, and identifying the timing of the event as determined at 310. Accordingly, to the extent there are differences in timing for a given class among different parties, these differences may be isolated to the parties themselves. For example, one payee may go to collections on a $10,000 debt after 90 days, whereas a different payee may go to collections on a $10,000 debt after 60 days.

After each available party having triggered events has been evaluated, automatic account modification system 100 may have built a set of expected triggered event timing data that may be used for subsequent processing (e.g., at 204, 206, and/or 208 as described below). Automatic account modification system 100 may store the expected triggered event timing data in memory, the cloud, or any other storage mechanism for future access and processing. Automatic account modification system 100 may occasionally and/or periodically repeat process 202 using new account data 170 and/or credit/reporting data 180 in order to refine and/or update the expected triggered event timing data.

FIG. 4 shows a process 204 for identifying event non-recurrence according to some embodiments of the disclosure. For example, account data 170 may include records of recurring account-related events, such as events that recur monthly or with some other periodicity, and automatic account modification system 100 may determine that a recurring event did not recur as expected on at least one occasion. Automatic account modification system 100 may perform process 204 to analyze a particular account and thereby enable subsequent processing (e.g., process 206 and/or process 208) to prevent or mitigate harm from external events by modifying one or more settings of the particular account.

In some embodiments, collection/event risk monitor 120 may be the component of automatic account modification system 100 that performs process 204. However, process 204 is described below with respect to automatic account modification system 100 generally to indicate that other embodiments may allow for other distributions of processing among components of automatic account modification system 100.

At 402, automatic account modification system 100 may identify previous recurring events in account data 170 for the account being analyzed. For example, automatic account modification system 100 may identify a monthly recurring event within account data including a plurality of events associated with the account. Automatic account modification system 100 may recognize one or more of the plurality of events as recurring events based on one or more respective characteristics of the events. For example, events having common or very similar characteristics may repeat in a recognizable pattern, and automatic account modification system 100 may identify such events as recurring events. Automatic account modification system 100 may also determine the period of the event's recurrence (e.g., daily, weekly, monthly, once every X days, etc.). Some examples of recurring events may be similar to those given above with respect to processing at 302 of process 202, although the processing at 402 is not limited to identifying those example events only.

At 404, automatic account modification system 100 may determine that a periodically (e.g., monthly) recurring event did not occur at an expected date. For example, the analysis at 402 may reveal that an event recurs on a same day of the week each week, a same date each month, etc. Thus, gaps in the periodic recurrence of the event may be identified. Automatic account modification system 100 may check the account data for each expected recurrence of the event and, if there is no record of the event in the account data for an expected date or range of dates, automatic account modification system 100 may determine that the event did not occur at the expected date. For example, the plurality of events associated with the account may have occurred over a plurality of months. In some such embodiments, the identifying of the recurring event may include identifying multiple events associated with a same party that reoccur on a monthly basis for at least two of the plurality of months and calculating, based on respective dates of each of the multiple events, the expected date for the monthly recurring event. Some examples of recurring events that did not occur may be similar to those given above with respect to processing at 304 of process 202, although the processing at 404 is not limited to identifying those example events only.

FIG. 5 shows a process 206 for determining a time to expected triggered event according to some embodiments of the disclosure. This may include predicting a time from an expected date to an expected triggered event that is triggered by a recurring event not occurring at the expected date. For example, using the expected triggered event timing data from 202, automatic account modification system 100 may be able to identify time elapsed between past triggered events and past missed recurring events of a similar type to the event that was determined not to recur at 204. Automatic account modification system 100 may base a time prediction on the identified previous elapsed times.

In some embodiments, collection/event risk monitor 120 may be the component of automatic account modification system 100 that performs process 206. However, process 206 is described below with respect to automatic account modification system 100 generally to indicate that other embodiments may allow for other distributions of processing among components of automatic account modification system 100.

At 502, automatic account modification system 100 may identify a class for the recurring event that did not recur as determined at 204. This may include determining a class of the recurring event from a plurality of classes. As described above with respect to processing at 202, events may be associated with classes, such as numeric value buckets and/or according to other classification schema. Automatic account modification system 100 may evaluate the characteristics of the recurring event that did not recur to classify it. By examining previous entries for the recurring event in account data 170, automatic account modification system 100 may identify its characteristics and classify it accordingly. For example, previous attendees to a weekly recurring meeting may be used to classify the meeting as a meeting of people of a certain group (e.g., executives, patent attorneys, linebackers, etc.). In another example, numeric values of previously-occurring events may be used to classify the event into a numeric value bucket (e.g., a meeting having 10 attendees into a 5-10 bucket, an event that is 3 hours long into a >2-hour bucket, a payment for $550 into a $500-999 bucket, etc.). Other classifications may be possible in other examples.

At 504, automatic account modification system 100 may identify a party associated with the recurring event that did not recur as determined at 204. By examining previous entries for the recurring event in account data 170, automatic account modification system 100 may identify its characteristics and, specifically, identify one or more parties to the event. For the meeting example, these may be attendees. For a payment example, this may be the payee or creditor. Other parties may be possible in other examples.

At 506, automatic account modification system 100 may determine a time from the missed recurring event to the expected triggered event based on the class of the event and the party associated with the event as determined at 502 and 504, respectively. This may include selecting, as the time from the expected date to the expected triggered event, an approximate elapsed time after which a party to the expected triggered event is known to have previously initiated triggered events for the determined class. As described above, at 202 automatic account modification system 100 may have determined this information for each party and stored it in expected triggered event timing data. Here, automatic account modification system 100 may access the expected triggered event timing data and identify, for the party to the missed recurring event, an expected triggered event timing for the class of event.

In some embodiments, automatic account modification system 100 may further apply an adjustment factor to the expected triggered event timing derived by accessing the expected triggered event timing data. Using the debt collection after missed payment example, the account may be a bank account into which the account holder deposits money from time to time. This may include direct deposits of paychecks and/or other predictable income sources. Automatic account modification system 100 may receive income prediction data associated with the account from one or more external sources (e.g., one or more account monitoring apps or services that are known to those of ordinary skill in the art). The income prediction data may include information predicting when funds will be deposited into the account, and how much will be deposited. In some cases, automatic account modification system 100 may revise the prediction upwards (i.e., to a longer time) based on detecting that income is likely to enter the account soon and may be used to pay double in the next installment payment. In other cases, automatic account modification system 100 may revise the prediction downwards (i.e., to a shorter time) based on detecting, in the income prediction data, a predicted reduction in income, suggesting that remedial action (e.g., as described below with respect to process 208) may be helpful earlier than otherwise would be expected.

FIG. 6 shows a process 208 for automatically modifying an account setting according to some embodiments of the disclosure. This may include automatically taking an action, and/or performing an automated action after obtaining user consent, that may prevent or mitigate an expected triggered event that was predicted at 206. By performing process 208, automatic account modification system 100 may leverage the prior work done at 202-206 to improve performance of account services 140 and/or other account management computer systems. In addition, automatic account modification system 100 may improve outcomes and/or prevent future events that would have otherwise occurred (e.g., the expected triggered event), thereby affecting external systems and realizing real-world benefits beyond the scope of automatic account modification system 100 itself.

In some embodiments, account modification engine 130 may be the component of automatic account modification system 100 that performs process 208. However, process 208 is described below with respect to automatic account modification system 100 generally to indicate that other embodiments may allow for other distributions of processing among components of automatic account modification system 100.

At 602, automatic account modification system 100 may determine that an expected triggered event is likely to occur. In some embodiments, this may include receiving the outcome of process 206, which may indicate an expected triggered event and a determined time when the event is expected to occur. Automatic account modification system 100 may take the presence of an expected triggered event as sufficient for continuing processing. In other embodiments, this may further include determining that the time when the event is expected to occur is sooner to the current time than some threshold level. Automatic account modification system 100 may examine outcomes of process 206 and identify any expected triggered events whose determined time of occurrence is less than a threshold value. In response to identifying such events, process 208 may continue. For example, an event may be predicted to occur on or near October 31. If the threshold time is 2 weeks, automatic account modification system 100 may make the determination on October 17 that an expected triggered event is likely to occur.

After determining that the expected triggered event is likely to occur at 602, some embodiments of automatic account modification system 100 may be configured to alert an account owner and receive a response from the account owner before modifying account settings. In this case, process 208 may proceed to 604. Other embodiments may automatically modify account settings without account owner intervention. In this case, process 208 may proceed to 608.

At 604, automatic account modification system 100 may alert an account owner or other entity of the likelihood of a triggered event occurring. For example, automatic account modification system 100 may perform processing to cause a message to be sent to a user associated with the account, based on contact information associated with the account. This may include sending an SMS or other message, or making a call, to a phone number; sending an email; presenting a message through an app or web portal; and/or other messaging types. The message may indicate that the expected triggered event is likely to occur and may include a description of the event, an expected date of the event, an expected time remaining to the event, and/or other information about the event. In some embodiments, the message may include one or more options for actions to be taken to mitigate harm from the event and/or prevent the event, such as the account settings modifications described in greater detail below. A user may select options using a computing device (e.g., phone, tablet, pc, etc.) by an interface provided in the message, by responding to the message, by logging into an app or web portal in response to receiving the message, etc.

At 606, automatic account modification system 100 may receive a command or other response from the account owner or other entity. For example, in response to the message sent at 604, a user may respond with a selection of one or more of the options for actions to be taken to mitigate harm from the event and/or prevent the event. For example, the user may select an option using their computing device, which may cause the computing device to send a message to automatic account modification system 100 through one or more networks such as the Internet or phone network.

At 608, automatic account modification system 100 may modify one or more account settings, either in response to receiving a command to do so at 606 or automatically after determining a triggered event is likely to occur at 602. In some embodiments, this may include performing processing that causes a server that manages the account to make an automatic modification to an account setting before the time from the expected date to the expected triggered event elapses. Examples of servers that manage the account (e.g., account services 140) may include, but are not limited to, a component of automatic account modification system 100 or a component of some other system with which automatic account modification system 100 is in communication, such as a business login account management system, a bank account management system, etc. For example, automatic account modification system 100 may send instructions through an application programming interface (API) of account services 140 to change a setting of account services 140 or change the setting through some other interface provided by account services 140.

The automatic modification may be configured to prevent the expected triggered event from occurring or to mitigate an effect of the expected triggered event. A variety of modifications may be possible, some examples of which are detailed below. Whether automatic account modification system 100 makes one or more of the example modifications or some other modifications, the effect may be to improve automatic account management operation (e.g., avoid data collisions such as those caused by double-booked time slots or the like, optimize timing of independent events so as to ensure funds are present for transactions or prevent mechanical breakdowns or provide other preferred outcomes, etc.) and/or to prevent the expected triggered events (e.g., prevent collections events, missed appointments, maintenance lapses, etc.).

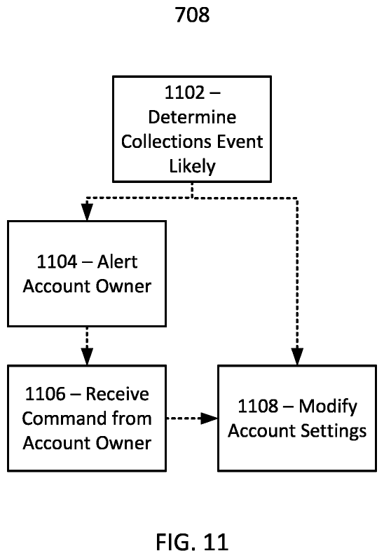

In one example, the automatic modification to the account setting may include changing a priority of future recurring events. For example, in an automatically managed account that is used to schedule mechanical operations, changing the order of operations may affect performance of the mechanical system for which operations are being scheduled. The expected triggered event identified by the automatic account modification system 100 may be a mechanical breakdown or a required servicing. By modifying the order of scheduled operations, automatic account modification system 100 may be able to prevent this expected triggered event, such as by rearranging scheduled activities so that a prescribed number appear before a scheduled maintenance activity rather than an excessive number. In another example, the expected triggered event identified by the automatic account modification system 100 may be a meeting that is likely to be skipped due to a double booking. By modifying another scheduled event to another time, automatic account modification system 100 may be able to prevent this expected triggered event by removing the double booking. As described in detail below with respect to FIG. 11, automatic account modification system 100 may change event priorities to avoid collections events in automatically managed bank accounts as well.

In another example, the automatic modification to the account setting may include canceling at least one future recurring event. For example, the expected triggered event identified by the automatic account modification system 100 may be a meeting that is likely to be skipped due to a double booking. By canceling one of the double-booked meetings, automatic account modification system 100 may be able to prevent this expected triggered event by removing the double booking. As described in detail below with respect to FIG. 11, automatic account modification system 100 may cancel certain scheduled transactions to avoid collections events in automatically managed bank accounts as well.

In another example, the automatic modification to the account setting may include establishing an automatic account modification protocol that is configured to cause a server that manages the account (e.g., account services 140) to make an automatic modification to an account setting in response to detecting a monthly recurring event associated with the class and the party failing to occur, for example any time the automatic account modification system 100 determines that the monthly recurring event associated with the class and the party has failed to occur. In other words, automatic account modification system 100 may establish an ongoing policy in addition to making the kinds of ad-hoc automatic modifications described above. After an expected triggered event is first detected and the modification to mitigate or prevent it is made as described above, the modification may be stored and maintained for future time periods. For example, if an account is modified to cancel a specific instance of a meeting, payment, scheduled mechanical activity, etc. in a given time period (e.g., for a given week, month, year, etc.), the modification may be carried over to future time periods. For example, automatic account modification system 100 may cause account services 140 to cancel all recurring payments of a certain type, or cancel all meetings scheduled for a certain date and time, etc.

Some embodiments may have more and/or different automatic account modifications than the aforementioned example automatic account modifications. Moreover, in some embodiments, multiple modifications may be made in any combination. Specific modifications available to automatic account modification system 100 and/or selected by automatic account modification system 100 may depend upon options offered for account modification by account services 140 and/or upon the nature of the expected event to be avoided or mitigated, for example.

FIG. 7 shows a process 700 for automatically modifying an account setting to avoid delinquency or provide some other remedy according to some embodiments of the disclosure. Process 700 is similar to process 200 described above with respect to FIG. 2, but is used specifically for modifying financial account management settings to avoid payment delinquencies or realize other financial benefits.

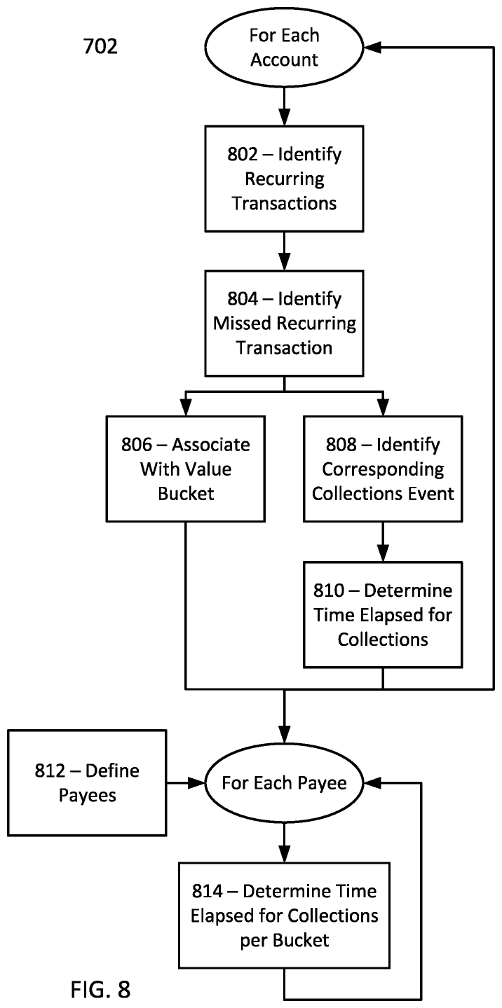

At 702, automatic account modification system 100 may build bill to collections timing data. For example, automatic account modification system 100 may correlate account-related events visible in account data 170 with subsequent external events visible in credit/reporting data 180. Specifically, missed recurring payments in account data 170 may be correlated with subsequent collections events in credit reports found in credit/reporting data 180. In some embodiments, automatic account modification system 100 may leverage access to generally inaccessible (e.g., private) data to make these correlations, such as private financial account data in account data 170 and/or individual credit reports of account holders in credit/reporting data 180. Specific processing that may be performed to build bill to collections timing data 702 is described in detail with respect to FIG. 8 below. Building bill to collections timing data is illustrated as part of process 700 herein, but in some embodiments, automatic account modification system 100 may receive pre-built bill to collections timing data from a data source and continue with process 700.

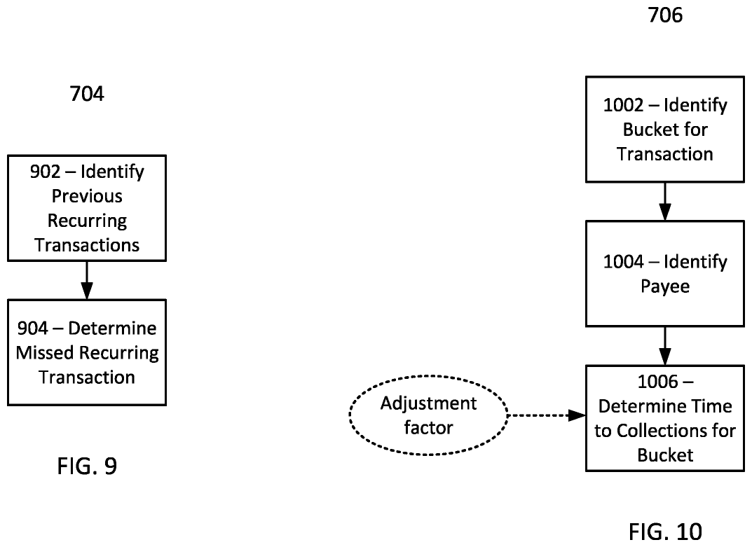

At 704, automatic account modification system 100 may identify possible payment delinquency. For example, account data 170 may include records of recurring payments, such as payments that recur monthly or with some other periodicity. Then, automatic account modification system 100 may determine that a recurring payment was not made for a given installment period (e.g., a monthly bill was not paid in a given month). Specific processing that may be performed to identify possible payment delinquency 704 is described in detail with respect to FIG. 9 below.

At 706, automatic account modification system 100 may determine a time to an expected collections event. For example, using the bill to collections timing data from 702, automatic account modification system 100 may be able to identify time elapsed between past collections referrals in credit reports and past missed payments of a similar type to and/or with a same payee as the missed payment identified at 704. Automatic account modification system 100 may base a time prediction on the identified previous elapsed times. Specific processing that may be performed to determine a time to an expected collections event 706 is described in detail with respect to FIG. 10 below.

At 708, automatic account modification system 100 may perform automatic account setting modification. Based on the nature of the expected triggered event, one or more account modifications may be available to mitigate harm from the expected triggered event and/or prevent the expected triggered event from occurring altogether. For example, these modifications may be configured to avoid having a payment account go into delinquency and thus be referred to collections. In another example, these modifications may be configured to increase the level of funds in the account so that payments can resume. Automatic account modification system 100 may identify these modifications and apply them directly or, in some cases, after obtaining user consent. Specific processing that may be performed to automatically modify an account setting 708 is described in detail with respect to FIG. 11 below.

FIG. 8 shows a process 702 for building bill to collections timing data according to some embodiments of the disclosure. Automatic account modification system 100 may perform process 702 as a preliminary setup procedure to enable subsequent account monitoring and automatic modification in some embodiments. The bill to collections timing data may be used for account monitoring, as described below with respect to FIG. 9, for example. Process 702 may be considered a special case or a particular example of process 202, with applicability to determining a time elapsed between when a payment on a debt is missed and when the debt is sent to collections.

In some embodiments, collection/event data builder 110 may be the component of automatic account modification system 100 that performs process 702. However, process 702 is described below with respect to automatic account modification system 100 generally to indicate that other embodiments may allow for other distributions of processing among components of automatic account modification system 100.

Automatic account modification system 100 may take account data 170 for a plurality of accounts and credit/reporting data 180 for the same plurality of accounts (or some subset of the plurality of accounts or overlapping set including at least some of the same accounts) as inputs. For each account indicated in or associated with the account data 170, automatic account modification system 100 may perform processing at 302-310.

At 802, automatic account modification system 100 may identify a periodically (e.g., monthly) recurring transaction event within account data of an account being analyzed. The account data may include a plurality of transactions and/or other events associated with the account. Automatic account modification system 100 may recognize one or more of the plurality of events as recurring events based on one or more respective characteristics of the events. For example, events having common or very similar characteristics may repeat in a recognizable pattern, and automatic account modification system 100 may identify such events as recurring events. Automatic account modification system 100 may also determine the period of the event's recurrence (e.g., daily, weekly, monthly, once every X days, etc.).

For example, account data 170 may include records of payments made to a same payee at or near the same time every month. In some cases, such as installment payments, these may be for the same dollar amount every month and may be on the same date (with the possible exception of shifting to a day or two before or after the same date when the date falls on a Saturday or Sunday). For example, an account holder may pay a bank $500 on the 4^{th} of every month for a car loan. In other cases, such as credit card payments, these may be on a same or nearly same date but may vary in amount from month to month. For example, a credit card payment may be due to a bank on the 15^{th} of every month, and the account holder may pay the bank on the 15^{th} or a few days before every month, although the value may vary depending on the credit card bill. In either case, account data 170 may indicate information useful to identify the payment, such as the payee, the value, the date, and an account number or receipt number or other identifier. Periodic repetition over time of these data may allow automatic account modification system 100 to identify the recurring payment While the above examples use monthly periods, automatic account modification system 100 may be able to detect recurring transactions of any periodicity, such as daily, weekly, and/or annual transactions.

If no recurring transactions are identified for a given account, automatic account modification system 100 may select another account for analysis and repeat processing at 802 with the new account's data. If there are no further accounts to analyze, process 702 may end.

At 804, automatic account modification system 100 may determine that a periodically (e.g., monthly) recurring transaction identified at 802 did not occur at an expected date. For example, the analysis at 802 may reveal that a payment of $500 is made on or about the 10^{th} of every month to Capital One Bank for account number 123456789. Thus, gaps in the periodic recurrence of the event may be identified. For example, automatic account modification system 100 may check the account data for each expected recurrence of the transaction and, if there is no record of the transaction in the account data, automatic account modification system 100 may determine that the transaction did not occur at the expected date. For example, there may be no payment to Capital One Bank for account number 123456789 for the month of October. In this event, automatic account modification system 100 may determine that the recurring transaction did not occur at the expected date.

If no recurring transactions are identified as being missed at an expected date for a given account, automatic account modification system 100 may select another account for analysis and repeat processing at 802 and 804 with the new account's data. If there are no further accounts to analyze, process 702 may end.

At 806, for any recurring transactions(s) that were identified as being missed at 804, automatic account modification system 100 may associate the missed transaction with a class indicative of its value (“value bucket” or “bucket”). For example, automatic account modification system 100 may determine a bucket of the monthly recurring transaction from a plurality of transaction value buckets. In some embodiments, each of the plurality of classes may correspond to a respective range of transaction values. In some such embodiments, transactions may be placed into buckets according to their values. For example, there may be buckets for values of $0-9, $10-49, $50-99, $100-499, etc. Other ranges and/or currencies may be used, and these are presented for example only. As such, low value transactions may be assigned different buckets from higher value transactions, for example.

At 808, for any recurring transaction(s) that were identified as being missed at 804, automatic account modification system 100 may identify a triggered collections event corresponding to the missed monthly recurring transaction within credit/reporting data 180. At this stage of process 702, automatic account modification system 100 may be able to correlate the missed payments with the subsequent collections events visible in credit/reporting data 180. To make the correlation, automatic account modification system 100 may identify, within credit/reporting data 180, an event that corresponds to the missed payment that originated from account data 170. For example, the respective collection events can be correlated with the respective missed payments by common or related characteristics. For example, a collections event in the same dollar amount as a missed payment identified at 804, and in some cases having the same payee, may be correlated due to the same amount and/or same payee. In Any criteria may be matched or otherwise correlated to identify corresponding triggered collections events.

As noted above, some embodiments of automatic account modification system 100 may leverage access to generally inaccessible (e.g., private) data to make these correlations. Examples of generally inaccessible data may include, but are not limited to, private account information (e.g., in account data 170) that automatic account modification system 100 may only have due to being integrated with an account management service and/or private credit or other data (e.g., in credit/reporting data 180) that automatic account modification system 100 may only have due to prior consent from account holders.

At 810, automatic account modification system 100 may determine an elapsed time between the expected date of the missed payment and the triggered collections event. Here, automatic account modification system 100 may perform a calculation determining the difference between a scheduled or otherwise expected date and/or time for the missed payment and a time indicated in credit/reporting data 180 for the triggered collections event. The scheduled or otherwise expected date and/or time for the missed event payment have been determined at 802 (e.g., the expected time and/or date based on previous patterns). Credit/reporting data 180 may indicate the triggered collections event's time and/or date either by including it in the description of the collections event or by first showing up within credit/reporting data 180 at a particular time and/or date, for example.

Automatic account modification system 100 may perform processing at 802-810 for each account indicated in or associated with the account data 170. Accordingly, as illustrated in FIG. 8, processing at 802-810 may be repeated until all available accounts (or a desired subset thereof) have been evaluated as described.

After processing at 802-810 for a plurality of accounts, automatic account modification system 100 may have a data set indicating expected timings for a variety of transactions and buckets. For example, for each of the respective buckets, a subsequent triggered collections event may have an expected timing. Specifically, for illustration purposes only, a collections event may occur 60 days after a missed payment in a $100-499 bucket, whereas a collections event may occur 30 days after a missed payment in a $1000-1999 bucket. However, some embodiments may further define event timings not only based on buckets, but also based on the tendencies of a plurality of parties to the collection events (e.g., payees or collections agencies). For example, there may be a plurality of different payees that show up in the credit/reporting data 180. Different payees may trigger collection events at different timings (e.g., as determined at 810). For each payee, automatic account modification system 100 may perform processing at 812-814 to identify differences in timing among payees, even for similar value buckets.

At 812, automatic account modification system 100 may define the payees in some embodiments. In some cases, automatic account modification system 100 may receive or access a list of payees associated with credit/reporting data. In other cases, automatic account modification system 100 may read credit/reporting data and identify payees whose debts were sent to collections (for example, entities listed in “payee” fields or other fields associated with identifiable parties).

At 814, automatic account modification system 100 may determine times elapsed per events per bucket for each payee. For example, automatic account modification system 100 may determine an approximate elapsed time for the bucket and the party as an output of a calculation using each of a plurality of respective elapsed times as input. This may be done, for example, by selecting each missed payment identified at 808 for a given payee, identifying the bucket, and identifying the timing of the collections event as determined at 810. Accordingly, to the extent there are differences in timing for a given bucket among different payees, these differences may be isolated to the payees themselves. For example, one payee may go to collections on a $10,000 debt after 90 days, whereas a different payee may go to collections on a $10,000 debt after 60 days.

After each available payee having triggered collections events has been evaluated, automatic account modification system 100 may have built a set of bill to collections timing data that may be used for subsequent processing (e.g., at 704, 706, and/or 708 as described below). Automatic account modification system 100 may store the bill to collections timing data in memory, the cloud, or any other storage mechanism for future access and processing. Automatic account modification system 100 may occasionally and/or periodically repeat process 702 using new account data 170 and/or credit/reporting data 180 in order to refine and/or update the bill to collections timing data.

FIG. 9 shows a process 704 for identifying possible delinquency according to some embodiments of the disclosure. For example, account data 170 may include records of recurring transactions, such as transactions that recur monthly or with some other periodicity, and automatic account modification system 100 may determine that a recurring transaction did not recur as expected on at least one occasion. Automatic account modification system 100 may perform process 704 to analyze a particular account and thereby enable subsequent processing (e.g., process 706 and/or process 708) to prevent or mitigate harm from external events by modifying one or more settings of the particular account. For example, it may be possible to prevent debts from being sent to collection and/or to make funds available for servicing of debts through account settings changes.

In some embodiments, collection/event risk monitor 120 may be the component of automatic account modification system 100 that performs process 704. However, process 704 is described below with respect to automatic account modification system 100 generally to indicate that other embodiments may allow for other distributions of processing among components of automatic account modification system 100.

At 902, automatic account modification system 100 may identify previous recurring transactions in account data 170 for the account being analyzed. For example, automatic account modification system 100 may identify a monthly recurring transaction within account data including a plurality of transactions associated with the account. Automatic account modification system 100 may recognize one or more of the plurality of transactions as recurring transactions based on one or more respective characteristics of the transactions. For example, transactions having common or very similar characteristics may repeat in a recognizable pattern, and automatic account modification system 100 may identify such transactions as recurring transactions. Automatic account modification system 100 may also determine the period of the transaction's recurrence (e.g., daily, weekly, monthly, once every X days, etc.). Some examples of recurring transactions may be similar to those given above with respect to processing at 802 of process 202, although the processing at 902 is not limited to identifying those example transactions only.

At 904, automatic account modification system 100 may determine that a periodically (e.g., monthly) recurring transactions did not occur at an expected date. For example, the analysis at 902 may reveal that a transaction recurs on a same day of the week each week, a same date each month, etc. Thus, gaps in the periodic recurrence of the transaction may be identified. Automatic account modification system 100 may check the account data for each expected recurrence of the transaction and, if there is no record of the transaction in the account data for an expected date or range of dates, automatic account modification system 100 may determine that the transaction did not occur at the expected date. For example, the plurality of transactions associated with the account may have occurred over a plurality of months. In some such embodiments, the identifying of the recurring transaction may include identifying multiple transactions associated with a same party (e.g., a same payee) that reoccur on a monthly basis for at least two of the plurality of months and calculating, based on respective dates of each of the multiple transactions, the expected date for the monthly recurring transaction. Some examples of recurring transactions that did not occur may be similar to those given above with respect to processing at 804 of process 702, although the processing at 904 is not limited to identifying those example transactions only.

FIG. 10 shows a process 706 for determining a time to collections event according to some embodiments of the disclosure. This may include predicting a time from an expected date to an expected collections event that is triggered by a transaction not occurring at the expected date. For example, using the bill to collections timing data from 702, automatic account modification system 100 may be able to identify time elapsed between past collections referrals in credit reports and past missed payments of a similar type to and/or with a same payee as the missed payment identified at 704. Automatic account modification system 100 may base a time prediction on the identified previous elapsed times.

In some embodiments, collection/event risk monitor 120 may be the component of automatic account modification system 100 that performs process 706. However, process 706 is described below with respect to automatic account modification system 100 generally to indicate that other embodiments may allow for other distributions of processing among components of automatic account modification system 100.

At 1002, automatic account modification system 100 may identify a bucket for the recurring transaction that did not recur as determined at 704. This may include selecting a bucket of the recurring transaction from a plurality of buckets. As described above with respect to processing at 702, automatic account modification system 100 may evaluate the characteristics of the recurring transaction that did not recur to classify it. By examining previous entries for the recurring transaction in account data 170, automatic account modification system 100 may identify its characteristics and classify it accordingly. For example, each of the plurality of classes may correspond to a respective range of transaction values. In some such embodiments, transactions may be placed into buckets according to their values. For example, there may be buckets for values of $0-9, $10-49, $50-99, $100-499, etc. Other ranges and/or currencies may be used, and these are presented for example only. As such, low value transactions may be assigned different buckets from higher value transactions, for example. Other classifications may be possible in other examples. In any case, automatic account modification system 100 may determine a bucket of the monthly recurring transaction from a plurality of transaction value buckets.

At 1004, automatic account modification system 100 may identify a party associated with the recurring transaction that did not recur as determined at 704. For example, the party may be the payee. By examining previous entries for the recurring transaction in account data 170, automatic account modification system 100 may identify its characteristics and, specifically, identify the payee.

At 1006, automatic account modification system 100 may determine a time from the missed recurring transaction to the expected collections event based on the class of the transaction and the payee associated with the transaction as determined at 1002 and 1004, respectively. This may include selecting, as the time from the expected date to the expected collections event, an approximate elapsed time after which the payee is known to have previously initiated collections events for the determined bucket. As described above, at 702 automatic account modification system 100 may have determined this information for each payee and stored it in bill to collections timing data. Here, automatic account modification system 100 may access the bill to collections timing data and identify, for the payee involved, an expected time to collections for the bucket into which the transaction falls.

In some embodiments, automatic account modification system 100 may further apply an adjustment factor to the expected time to collections derived by accessing the bill to collections timing data. For example, the account may be a bank account into which the account holder deposits money from time to time. This may include direct deposits of paychecks and/or other predictable income sources. Automatic account modification system 100 may receive income prediction data associated with the account from one or more external sources (e.g., one or more account monitoring apps or services that are known to those of ordinary skill in the art). The income prediction data may include information predicting when funds will be deposited into the account, and how much will be deposited. In some cases, automatic account modification system 100 may revise the prediction upwards (i.e., to a longer time) based on detecting that income is likely to enter the account soon and may be used to pay double in the next installment payment. In other cases, automatic account modification system 100 may revise the prediction downwards (i.e., to a shorter time) based on detecting, in the income prediction data, a predicted reduction in income, suggesting that remedial action (e.g., as described below with respect to process 208) may be helpful earlier than otherwise would be expected.

FIG. 11 shows a process 708 for automatically modifying an account setting to avoid delinquency or provide some other remedy according to some embodiments of the disclosure. This may include automatically taking an action, and/or performing an automated action after obtaining user consent, that may prevent or mitigate a collections event that was predicted at 706. By performing process 708, automatic account modification system 100 may leverage the prior work done at 702-706 to improve performance of account services 140 and/or other account management computer systems. In addition, automatic account modification system 100 may improve outcomes and/or prevent future events that would have otherwise occurred (e.g., the expected collections event), thereby affecting external systems and realizing real-world benefits beyond the scope of automatic account modification system 100 itself.

In some embodiments, account modification engine 130 may be the component of automatic account modification system 100 that performs process 708. However, process 708 is described below with respect to automatic account modification system 100 generally to indicate that other embodiments may allow for other distributions of processing among components of automatic account modification system 100.

At 1102, automatic account modification system 100 may determine that a collections event is likely to occur. In some embodiments, this may include receiving the outcome of process 706, which may indicate an expected collections event and a determined time when the collections event is expected to occur. Automatic account modification system 100 may take the presence of an expected collections event as sufficient for continuing processing. In other embodiments, this may further include determining that the time when the collections event is expected to occur is sooner to the current time than some threshold level. Automatic account modification system 100 may examine outcomes of process 706 and identify any expected collections events whose determined time of occurrence is less than a threshold value. In response to identifying such events, process 708 may continue. For example, a debt may be predicted to be sent to collections on or near November 1. If the threshold time is 2 weeks, automatic account modification system 100 may make the determination on October 18 that a debt is likely to be sent to collections.

After determining that the collections event is likely to occur at 1102, some embodiments of automatic account modification system 100 may be configured to alert an account owner and receive a response from the account owner before modifying account settings. In this case, process 708 may proceed to 1104. Other embodiments may automatically modify account settings without account owner intervention. In this case, process 708 may proceed to 1108.

At 1104, automatic account modification system 100 may alert an account owner or other entity of the likelihood of a debt of the account holder being sent to collections. For example, automatic account modification system 100 may perform processing to cause a message to be sent to a user associated with the account, based on contact information associated with the account. This may include sending an SMS or other message, or making a call, to a phone number; sending an email; presenting a message through an app or web portal; and/or other messaging types. The message may indicate that the debt is likely to be sent to collections and may include a description of the debt and/or payee, an expected date it will go to collections, an expected time remaining until it goes to collections, and/or other information. In some embodiments, the message may include one or more options for actions to be taken to mitigate harm and/or prevent the debt going to collections, such as the account settings modifications described in greater detail below. A user may select options using a computing device (e.g., phone, tablet, pc, etc.) by an interface provided in the message, by responding to the message, by logging into an app or web portal in response to receiving the message, etc.

At 1106, automatic account modification system 100 may receive a command or other response from the account owner or other entity. For example, in response to the message sent at 1104, a user may respond with a selection of one or more of the options for actions to be taken to mitigate harm and/or prevent the debt being sent to collections. For example, the user may select an option using their computing device, which may cause the computing device to send a message to automatic account modification system 100 through one or more networks such as the Internet or phone network.

At 1108, automatic account modification system 100 may modify one or more account settings, either in response to receiving a command to do so at 1106 or automatically after determining a collections event is likely to occur at 1102. In some embodiments, this may include performing processing that causes a server that manages the account to make an automatic modification to an account setting before the time from the expected date to the expected collections event elapses. Examples of servers that manage the account (e.g., account services 140) may include, but are not limited to, a component of automatic account modification system 100 or a component of some other system with which automatic account modification system 100 is in communication, such as a bank account management system. For example, automatic account modification system 100 may send instructions through an application programming interface (API) of account services 140 to change a setting of account services 140 or change the setting through some other interface provided by account services 140.

The automatic modification may be configured to prevent the debt from going to collections or to mitigate overall harm to the financial health of the account. A variety of modifications may be possible, some examples of which are detailed below. Whether automatic account modification system 100 makes one or more of the example modifications or some other modifications, the effect may be to improve automatic account management operation (e.g., optimize timing of independent events so as to ensure funds are present for transactions, prioritize payment of more important debts, etc.) and/or to prevent the expected collections event altogether.

In one example, the automatic modification to the account setting may include changing a priority of future recurring events. For example, assume the amount of the missed transaction for the debt that is expected to be sent to collections is $500, the current date is June 1, and the debt is expected to be sent to collections on June 15. The account may have $400 in it on June 1, and the account may receive a direct deposit in the amount of $400 every June 10. Moreover, the account may have recurring payments of $200 scheduled for June 5 and $300 scheduled for June 8. After performing processing to identify recurring transactions in account data 170 as described above, automatic account modification system 100 may have data indicating each of these points. Automatic account modification system 100 change transaction priorities to prevent the collection event on June 15, for example by moving either or both of the recurring payments to a date after June 15 and scheduling the $500 payment for the debt that is expected to be sent to collections.

In another example, the automatic modification to the account setting may include canceling at least one future recurring event. Continuing the example above, automatic account modification system 100 may cancel one of the $200 or $300 recurring payments for the month, or both, in preference to the $500 payment. In some cases, for example when the adjustment factor (as described above with respect to processing at 1006 of process 706) indicates that the direct deposit is likely to be less this month, or a non-scheduled payment is likely to be made this month, automatic account modification system 100 may recommend canceling of certain recurring transactions altogether and/or automatically cancel such transactions. For example, based on data describing a transaction, the transaction may be assigned a low priority by automatic account modification system 100. One example may be an entertainment subscription service such as a streaming video service or streaming music service. Automatic account modification system 100 may prioritize payments for other services (e.g., utility bills, rent, etc.) over such subscriptions, directing account services 140 to delay or cancel payments to the latter.

In another example, the automatic modification to the account setting may include establishing an automatic account modification protocol that is configured to cause a server that manages the account (e.g., account services 140) to make an automatic modification to an account setting in response to the prediction of an imminent collections event. In other words, automatic account modification system 100 may establish an ongoing policy in addition to making the kinds of ad-hoc automatic modifications described above. After an expected collections event is first detected and the modification to mitigate or prevent it is made as described above, the modification may be stored and maintained for future time periods. For example, if an account is modified to cancel a payment to a particular payee in a given month or other time period, the modification may be carried over to future time periods. For example, automatic account modification system 100 may cause account services 140 to cancel all recurring payments of an entertainment subscription service in order to keep a baseline level of funding in the account to cover a more important debt on a day of the month at which the payment for the latter debt is deposited. In another example, automatic account modification system 100 may establish an ongoing policy whereby when future expected collections events are detected for the same recurring transaction or for other recurring transactions, the same modification may be applied to the account.

Some embodiments may have more and/or different automatic account modifications than the aforementioned example automatic account modifications. Moreover, in some embodiments, multiple modifications may be made in any combination. Specific modifications available to automatic account modification system 100 and/or selected by automatic account modification system 100 may depend upon options offered for account modification by account services 140 and/or upon the nature of the expected event to be avoided or mitigated, for example.

FIG. 12 shows a computing device 1200 according to some embodiments of the disclosure. For example, computing device 1200 may function as any element within account modification system 100 (e.g., collection/event data builder 110, collection/event risk monitor 120, and/or account modification engine 130) and/or other systems that may be included within or may be in communication with account modification system 100 (e.g., account services 140, user device 150, and/or income prediction engine 160), any combinations thereof, or any portions thereof. In some embodiments, computing device 1200 may host one or more of account data 170 and/or credit/reporting data 180 in one or more databases or other storage. Computing device 1200 may be implemented on any electronic device that runs software applications derived from compiled instructions, including without limitation personal computers, servers, smart phones, media players, electronic tablets, game consoles, email devices, etc. In some implementations, computing device 1200 may include one or more processors 1202, one or more input devices 1204, one or more display devices 1206, one or more network interfaces 1208, and one or more computer-readable mediums 1210. Each of these components may be coupled by bus 1212, and in some embodiments, these components may be distributed among multiple physical locations and coupled by a network.

Display device 1206 may be any known display technology, including but not limited to display devices using Liquid Crystal Display (LCD) or Light Emitting Diode (LED) technology. Processor(s) 1202 may use any known processor technology, including but not limited to graphics processors and multi-core processors. Input device 1204 may be any known input device technology, including but not limited to a keyboard (including a virtual keyboard), mouse, track ball, and touch-sensitive pad or display. Bus 1212 may be any known internal or external bus technology, including but not limited to ISA, EISA, PCI, PCI Express, NuBus, USB, Serial ATA or FireWire. In some embodiments, some or all devices shown as coupled by bus 1212 may not be coupled to one another by a physical bus, but by a network connection, for example. Computer-readable medium 1210 may be any medium that participates in providing instructions to processor(s) 1202 for execution, including without limitation, non-volatile storage media (e.g., optical disks, magnetic disks, flash drives, etc.), or volatile media (e.g., SDRAM, ROM, etc.).

Computer-readable medium 1210 may include various instructions 1214 for implementing an operating system (e.g., Mac OS®, Windows®, Linux). The operating system may be multi-user, multiprocessing, multitasking, multithreading, real-time, and the like. The operating system may perform basic tasks, including but not limited to: recognizing input from input device 1204; sending output to display device 1206; keeping track of files and directories on computer-readable medium 1210; controlling peripheral devices (e.g., disk drives, printers, etc.) which can be controlled directly or through an I/O controller; and managing traffic on bus 1212. Network communications instructions 1216 may establish and maintain network connections (e.g., software for implementing communication protocols, such as TCP/IP, HTTP, Ethernet, telephony, etc.).

Database 1218 may store account data 170, credit/reporting data 180, and/or other data such as determinations made as described above to make account modifications. Collection/event detection/avoidance instructions 1220 may include instructions that enable computing device 1200 to provide account modification system 100 functionality and/or related processing as described herein. Application(s) 1222 may be an application that uses or implements the processes described herein and/or other processes, for example applications used to view, manipulate, and/or otherwise access accounts. The processes may also be implemented in operating system 1214.

The described features may be implemented in one or more computer programs that may be executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment.

Suitable processors for the execution of a program of instructions may include, by way of example, both general and special purpose microprocessors, and the sole processor or one of multiple processors or cores, of any kind of computer. Generally, a processor may receive instructions and data from a read-only memory or a random access memory or both. The essential elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as an LED or LCD monitor for displaying information to the user and a keyboard and a pointing device such as a mouse or a trackball by which the user can provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination thereof. The components of the system may be connected by any form or medium of digital data communication such as a communication network. Examples of communication networks include, e.g., a telephone network, a LAN, a WAN, and the computers and networks forming the Internet.

The computer system may include clients and servers. A client and server may generally be remote from each other and may typically interact through a network. The relationship of client and server may arise by virtue of computer programs running on the respective computers and having a client-server relationship to each other.

One or more features or steps of the disclosed embodiments may be implemented using an API. An API may define one or more parameters that are passed between a calling application and other software code (e.g., an operating system, library routine, function) that provides a service, that provides data, or that performs an operation or a computation.

The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API.

In some implementations, an API call may report to an application the capabilities of a device running the application, such as input capability, output capability, processing capability, power capability, communications capability, etc.

Various embodiments may provide a data mining model that can make personalized partner offer product recommendations to users. By personalizing the recommendations, users engage with products more, gain trust in the recommendations, and convert to signing up following the recommendations. In addition to the technical benefits described above, the systems and methods described herein can provide increased user engagement and trust, increased conversion resulting in more money through offering partners, and better partner relationships.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

What is claimed is:

1. A method comprising:
identifying, with a processor, a recurring event within account data including a plurality of events associated with an account;
determining, with the processor, that the recurring event did not occur at an expected date;
predicting, with the processor, a time from the expected date to an expected triggered event that is triggered by the recurring event not occurring at the expected date, the predicting comprising:
determining a class of the recurring event from a plurality of classes; and
selecting, as the time from the expected date to the expected triggered event, an approximate elapsed time after which a party to the expected triggered event is known to have previously initiated triggered events for the determined class; and
before the time from the expected date to the expected triggered event elapses, causing, by the processor, a server that manages the account to make an automatic modification to an account setting, the automatic modification being configured to prevent the expected triggered event from occurring or to mitigate an effect of the expected triggered event.

2. The method of claim 1, wherein:
the plurality of events associated with the account occurred over a plurality of months; and
the identifying of the recurring event comprises:
identifying multiple events associated with the party to the expected triggered event that reoccur on a monthly basis for at least two of the plurality of months; and
calculating, based on respective dates of each of the multiple events, the expected date for the recurring event.

3. The method of claim 1, wherein:
each of the plurality of classes corresponds to a respective range of numeric values; and
the determining of the class of the recurring event comprises identifying a numeric value for the recurring event and assigning the recurring event to the class corresponding to the range in which the numeric value for the recurring event lies.

4. The method of claim 1, wherein the predicting further comprises:
receiving income prediction data associated with the account;
detecting, in the income prediction data, a predicted reduction in income; and
adjusting the time from the expected date to the expected triggered event downward in response to the predicted reduction in income.

5. The method of claim 1, wherein the automatic modification to the account setting comprises changing a priority of future recurring events, canceling at least one future recurring event, or a combination thereof.

6. The method of claim 1, wherein the recurring event is a payment, the expected triggered event is a collections event, and the party is a payee, the selecting comprising determining the approximate elapsed time from at least one time between at least one previously missed payment and at least one previous collections event in credit report data associated with the payee and the class.

7. The method of claim 1, wherein the predicting further comprises:
for each of a plurality of additional accounts, performing processing including:
identifying, with the processor, a respective recurring event within respective account data including a respective plurality of events associated with the respective account of the plurality of additional accounts;
determining, with the processor, that the respective recurring event did not occur at a respective expected date;
determining, with the processor, a class of the respective recurring event from the plurality of classes;
identifying, with the processor, a respective triggered event corresponding to the respective recurring event within reporting data, the respective triggered event associated with the party; and
determining, with the processor, a respective elapsed time between the respective expected date and the respective triggered event; and
determining, with the processor, the approximate elapsed time after which a party to the expected triggered event is known to have previously initiated triggered events for the determined class as an output of a calculation using each of the respective elapsed times as input.

8. A method comprising:
for each of a plurality of accounts, performing processing including:
identifying, with a processor, a respective recurring event within respective account data including a respective plurality of events associated with the respective account of the plurality of accounts;
determining, with the processor, that the respective recurring event did not occur at a respective expected date;
determining, with the processor, a class of the respective recurring event from a plurality of classes;
identifying, with the processor, a respective triggered event corresponding to the respective recurring event within reporting data, the respective triggered event associated with a party; and
determining, with the processor, a respective elapsed time between the respective expected date and the respective triggered event;
determining, with the processor, an approximate elapsed time for the class and the party as an output of a calculation using each of the respective elapsed times as input;
establishing, by the processor, an automatic account modification protocol that is configured to cause a server that manages at least one of an additional account and one or more of the plurality of accounts to make an automatic modification to an account setting in response to detecting a recurring event associated with the class and the party failing to occur; and
automatically modifying the account setting according to the automatic account modification protocol.

9. The method of claim 8, wherein, for each of the plurality of accounts:
the respective plurality of events associated with the respective account occurred over a plurality of months; and
the identifying of the respective recurring event comprises:
identifying multiple events associated with the party to the respective expected triggered event that reoccur on a monthly basis for at least two of the plurality of months; and
calculating, based on respective dates of each of the multiple events, the respective expected date for the respective recurring event.

10. The method of claim 8, wherein:
each of the plurality of classes corresponds to a respective range of numeric values; and
for each of the plurality of accounts, the determining of the class of the respective recurring event comprises identifying a respective numeric value for the respective recurring event and assigning the respective recurring event to the class corresponding to the range in which the respective numeric value for the respective recurring event lies.

11. The method of claim 8, wherein the automatic modification to the account setting comprises changing a priority of future recurring events, canceling at least one future recurring event, or a combination thereof.

12. The method of claim 8, wherein the automatic account modification protocol comprises detecting that the recurring event associated with the class and the party has failed to occur.

13. The method of claim 8, wherein the automatic modification is configured to prevent an expected triggered event from occurring or to mitigate an effect of the expected triggered event.

14. A system comprising:
a processor configured to perform processing comprising:
identifying a recurring event within account data including a plurality of events associated with an account;
determining that the recurring event did not occur at an expected date; and
predicting a time from the expected date to an expected triggered event that is triggered by the recurring event not occurring at the expected date, the predicting comprising:
determining a class of the recurring event from a plurality of classes; and
selecting, as the time from the expected date to the expected triggered event, an approximate elapsed time after which a party to the expected triggered event is known to have previously initiated triggered events for the determined class; and
a server in communication with the processor configured to perform processing comprising, before the time from the expected date to the expected triggered event elapses, making an automatic modification to an account setting, the automatic modification being configured to prevent the expected triggered event from occurring or to mitigate an effect of the expected triggered event.

15. The system of claim 14, wherein:
the plurality of events associated with the account occurred over a plurality of months; and
the processor is configured to identify the recurring event by performing processing comprising:
identifying multiple events associated with the party to the expected triggered event that reoccur on a monthly basis for at least two of the plurality of months; and
calculating, based on respective dates of each of the multiple events, the expected date for the recurring event.

16. The system of claim 14, wherein:
each of the plurality of classes corresponds to a respective range of numeric values; and
the processor is configured to determine the class of the recurring event by performing processing comprising identifying a numeric value for the recurring event and assigning the recurring event to the class corresponding to the range in which the numeric value for the recurring event lies.

17. The system of claim 14, wherein the predicting further comprises:
receiving income prediction data associated with the account;
detecting, in the income prediction data, a predicted reduction in income; and
adjusting the time from the expected date to the expected triggered event downward in response to the predicted reduction in income.

18. The system of claim 14, wherein the server is configured to make the automatic modification to the account setting by performing processing comprising changing a priority of future recurring events, canceling at least one future recurring event, or a combination thereof.

19. The system of claim 14, wherein the recurring event is a payment, the expected triggered event is a collections event, and the party is a payee, the selecting comprising determining the approximate elapsed time from at least one time between at least one previously missed payment and at least one previous collections event in credit report data associated with the payee and the class.

20. The system of claim 14, wherein:
the processor is configured to perform the predicting by, for each of a plurality of additional accounts, performing processing including:
identifying a respective recurring event within respective account data including a respective plurality of events associated with the respective account of the plurality of additional accounts;
determining that the respective recurring event did not occur at a respective expected date;
determining a class of the respective recurring event from the plurality of classes;
identifying a respective triggered event corresponding to the respective recurring event within reporting data, the respective triggered event associated with the party; and
determining a respective elapsed time between the respective expected date and the respective triggered event; and
the processor is configured to determine the approximate elapsed time after which a party to the expected triggered event is known to have previously initiated triggered events for the determined class as an output of a calculation using each of the respective elapsed times as input.
